(19) United States
(12) Patent Application Publication
(10) Pub. No.: US 2003/0055848 A1
(43) Pub. Date: Mar. 20, 2003

(54) Method and apparatus for automatically archiving and clearing intellectual property

(76) Inventors: Katherine V. G. Dickinson, East Palo Alto, CA (US); Jos Marlowe, Mountain View, CA (US); James A. Gosling, Redwood City, CA (US)

Correspondence Address: PARK, VAUGHAN & FLEMING LLP, 508 SECOND STREET, SUITE 201, DAVIS, CA, 95616, US

(21) Appl. No.: 09/954,742

(22) Filed: Sep. 17, 2001

(51) Int. Cl. G06F 12/00

(52) U.S. Cl. 707/204

(57) ABSTRACT

One embodiment of the present invention provides a system for archiving and clearing a document for publication. Upon receiving the document, the system takes actions to archive the document in a database. In doing so, the system automatically records a date upon which the document is archived. Next, the system receives a request to clear the document for publication. This causes the system to send an approval request to a first clearing authority. Upon receiving an approval from the first clearing authority, the system proceeds to clear the document for publication. Otherwise, if a denial is received from the first clearing authority, the system prevents the document from being cleared for publication. In one embodiment of the present invention, when the system receives an approval from the first clearing authority, the system sends an approval request to a second clearing authority. Upon receiving an approval from the second clearing authority, the system clears the document for publication. Otherwise, if a denial is received from the second clearing authority, the system prevents the document from being cleared for publication.

### BACKGROUND

1. Field of the Invention

The present invention relates to data archiving systems and approval processes. More specifically, the present invention relates to a method and an apparatus for archiving and clearing intellectual property prior to publication.

2. Related Art

As the economy becomes increasingly more information-based, intellectual property is becoming more important. Companies often develop intellectual property at considerable expense by investing heavily in research and development. This investment is typically protected through a combination of patents, copyrights, trademarks and trade secrets. Unfortunately, there often exists a tension between the goals of preserving intellectual property rights, and publicizing new technological developments.

There exist significant incentives to publicize new technological developments. A company can often gain a competitive advantage in the marketplace by publishing or otherwise disclosing a promising new development in advance of when the development is incorporated into a product. Furthermore, researchers and engineers often have an interest in gaining personal recognition through publication of the new development.

Unfortunately, public disclosure of a new idea prior to applying for patent protection can in some cases bar subsequent patent rights. Hence, it is important to ensure that commercially significant ideas are not published until patents can be filed to protect the ideas.

Unfortunately, within most organizations the process of clearing ideas for publication is typically performed in an ad hoc manner. Many companies have no formal clearance process, and simply rely on the researchers or engineers to pursue patent protection prior to publication. Other companies have clearance processes, but these clearance processes typically involve acquiring signatures from a number of different authorities, which can create considerable paperwork and can cause considerable delay. Furthermore, many companies do not have a functioning system for establishing the date of conception of an idea, which can potentially be useful during subsequent patent office proceedings in proving that an inventor was the first to invent an idea.

What is needed is a method and an apparatus for efficiently archiving and clearing intellectual property prior to publication.

### SUMMARY

One embodiment of the present invention provides a system for archiving and clearing a document for publication. Upon receiving the document, the system takes actions to archive the document in a database. In doing so, the system automatically records a date upon which the document is archived. Next, the system receives a request to clear the document for publication. This causes the system to send an approval request to a first clearing authority. Upon receiving an approval from the first clearing authority, the system proceeds to clear the document for publication. Otherwise, if a denial is received from the first clearing authority, the system prevents the document from being cleared for publication.

In one embodiment of the present invention, when the system receives an approval from the first clearing authority, the system sends an approval request to a second clearing authority. Upon receiving an approval from the second clearing authority, the system clears the document for publication. Otherwise, if a denial is received from the second clearing authority, the system prevents the document from being cleared for publication.

In one embodiment of the present invention, the system provides the first clearing authority with a predetermined set of assumptions associated with approval of the document, so that the first clearing authority will understand the ramifications of approving the document.

In one embodiment of the present invention, the system sends the approval request to the first clearing authority through an email message or some other notification.

In one embodiment of the present invention, sending the approval request to the first clearing authority involves presenting the first clearing authority with a number of options. These options include: approving clearance of the document for publication; denying clearance of the document for publication; and triggering a full review of the document by legal staff to determine whether the document should be cleared for publication.

In a variation on this embodiment, when the system receives a request for a full review of the document from the first clearing authority, the system triggers a full review of the document by legal staff.

In one embodiment of the present invention, when the system receives a denial from the first clearing authority, the system allows the first clearing authority to state reasons for the denial.

In one embodiment of the present invention, when the system receives a request for additional information from the first clearing authority, the system forwards the request for additional information to the requesting party, and allows the requesting party to provide the additional information to the first clearing authority.

In one embodiment of the present invention, the system allows the first clearing authority to delegate approval authority.

### BRIEF DESCRIPTION OF THE FIGURES

FIG. 1 illustrates a number of computer systems coupled together through a network in accordance with an embodiment of the present invention.

FIG. 2 presents a flow chart of the approval process in accordance with an embodiment of the present invention.

FIG. 3 illustrates a form for receiving a document in accordance with an embodiment of the present invention.

FIG. 4 illustrates a window that is presented to a clearing authority in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Computer Systems

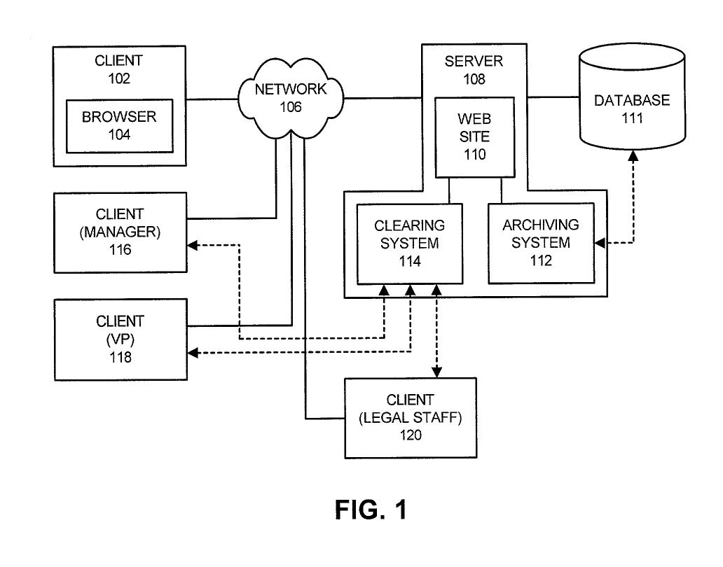

FIG. 1 illustrates a number of computer systems 102, 108, 116, 118 and 120 coupled together through a network 106 in accordance with an embodiment of the present invention. Computer systems 102, 108, 116, 118 and 120 can generally include any type of computer system, including, but not limited to, a computer system based on a microprocessor, a mainframe computer, a digital signal processor, a portable computing device, a personal organizer, a device controller, and a computational engine within an appliance.

Network 106 can generally include any type of wire or wireless communication channel capable of coupling together computing nodes. This includes, but is not limited to, a local area network, a wide area network, or a combination of networks. In one embodiment of the present invention, network 106 includes the Internet.

Computer systems 102, 108, 116, 118 and 120 include server 108 and a number of clients 102, 116, 118 and 120. Server 108 can generally include any computational node including a mechanism for servicing requests from a client for computational and/or data storage resources. Clients 102, 116, 118 and 120 can generally include any node on a network including computational capability and including a mechanism for communicating across network 106.

Client 102 includes a web browser 104. Browser 104 can generally include any type of web browser capable of viewing a web site, such as the INTERNET EXPLORER™ browser distributed by the Microsoft Corporation of Redmond, Wash.

Server 108 includes web site 110 which contains interlinked pages of textual and graphical information that can be navigated through by a user of web browser 104.

Web site 110 works in concert with archiving system 112 and clearing system 114. Archiving system 112 receives documents from a user of client 102 and stores them in database 111. Database 111 can include any type of system for storing data in non-volatile storage. This includes, but is not limited to, systems based upon magnetic, optical, and magneto-optical storage devices, as well as storage devices based on flash memory and/or battery-backed up memory.

Clearing system 114 communicates with clients 116, 118 and 120 to obtain approval to clear a specific document or set of documents stored in database 111. Note that client 116 is operated by a manager who supervises the user of client 102. Furthermore, note that client 118 belongs to a Vice President who oversees the manager. Note that the term “Vice President” as used in this specification can refer to a Vice President, a Vice President's delegate, someone higher than a Vice President, or anyone with Vice President or officer of the company authority. Finally, client 120 belongs to a member of the organization's legal staff who is empowered to undertake a full review of the document, if necessary.

In one embodiment of the present invention, a document is entered into the system through a form that is presented to the user through browser 104. Next, the document is transmitted to web site 110 and then into archiving system 112. Archiving system 112 records the document (or set of documents) within database 111. Note that the time of recording is stored with the document, and can subsequently be used to prove date of conception and/or reduction to practice.

After a document is archived, the system facilitates editing of the document. The system also facilitates searches on document attributes. For example, the system can search on an author name to locate all documents associated with a specific author. Documents can also be cross-referenced with hyperlinks.

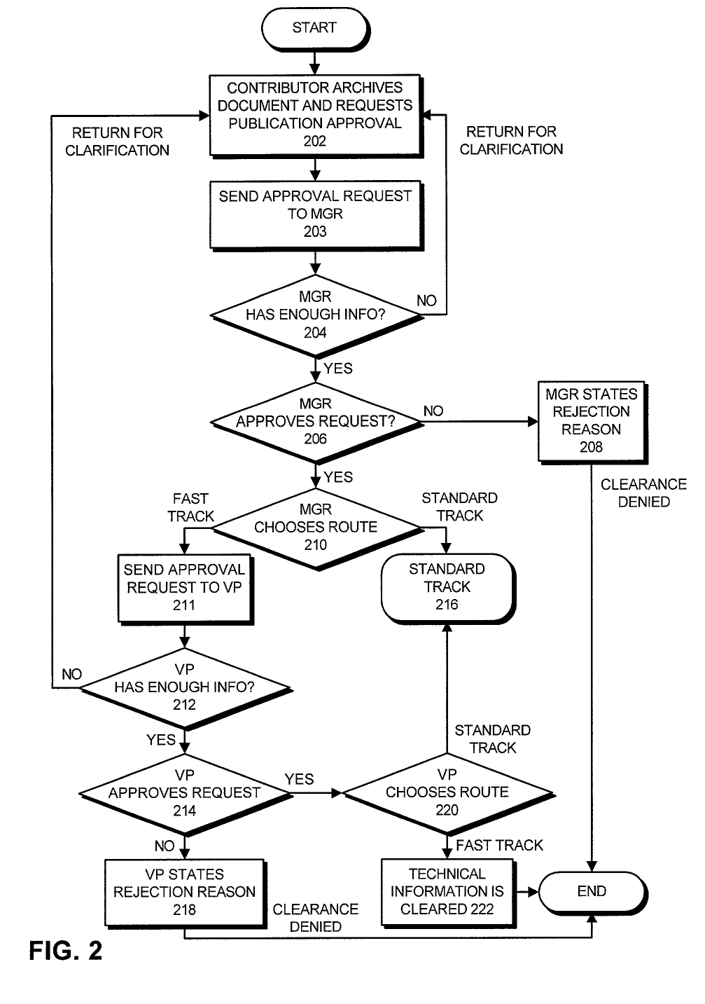

Once a document is archived, it can be cleared for publication by clearing system 114, which obtains approvals from some designated set of approvers, such as a manager (operating client 116), a Vice President (operating client 118) and a legal staff member (operating client 120). This clearing process is described in more detail below with reference to FIGS. 2 and 4.

Approval Process

FIG. 2 presents a flow chart of the approval process in accordance with an embodiment of the present invention. The system starts when a user of client 102 archives a document and requests approval for publication (step 202).

This causes an approval request to be sent to a manager at client 116 (step 203). Note that this approval request can be sent through an email message, or any other type of communication mechanism. At this point, the manager can ask for additional information, in which case the system returns to step 202 so that the requester can supply additional information. Otherwise, the system determines whether the manager approved the request (step 206). If not, the system allows the manager to state reasons for the rejection (step 208) and terminates the process.

If the manager approves the request, the system allows the manager to select either the “fast track” or the “standard track” (step 210). The fast track requires only an additional approval from a Vice President, which can take very little time if the Vice President is available. In contrast, the standard track involves a full review the document by a member of the legal staff and can potentially take many days or weeks to complete (step 216).

If the manager selects the fast track, the system sends an approval request to the Vice President through client 118 (step 211). At this point, the Vice President can ask for additional information, in which case the system returns to step 202 so that the requester can supply additional information. Otherwise, the system determines if the Vice President approved the request (step 214). If not, the system allows the Vice President to state reasons for the rejection (step 218) and terminates the process.

If the Vice President approves the request, the system allows the Vice President to select either the “fast track” or the “standard track” (step 220). If the Vice President selects the fast track, the document is cleared for publication (step 222). Otherwise, if the Vice President selects the standard track, the document is sent to a legal staff member at client 120 for a full review (step 216).

Inputting a Document

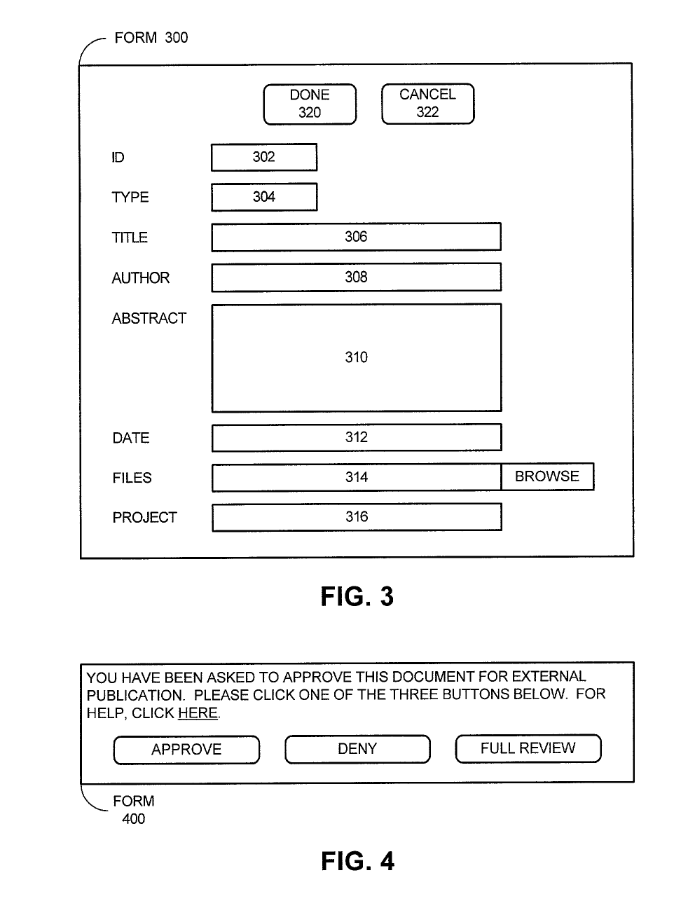

FIG. 3 illustrates a form 300 for inputting a document in accordance with an embodiment of the present invention. Form 300 is presented to a user of browser 104 to facilitate entering a document (or collection of related documents) for purposes of archiving. Form 300 includes a “done” button 320 to commit the document into the archive and a “cancel” button 322 to cancel archiving of the document. The ID field 302 allows the user to input a unique identifier for the document, which can include a year and a serial number. The type field 304 allows the user to select a document type from a pull-down menu. For example, a document can be a technical report, a schematic diagram, or an audio recording. The title field 306 allows the user to input a title for the document. The author field 308 allows the user to input one or more authors for the document. In one embodiment of the present invention, the system allows a user to indicate that a given author is an external author, who does not belong to the organization. The abstract field 310 provides space for a brief paragraph summarizing the contents of the document. The date field 312 indicates that date that the document is or was archived. This field is automatically filled in by the system. The “files” field 314 allows the user to browse through a file system to select one or more related files to be stored together in the archive. Finally, the project field 316 allows the user to associate the document with a specific project.

Approving a Document

FIG. 4 illustrates a window 400 that is presented to a clearing authority in accordance with an embodiment of the present invention. This window allows the clearing authority to select from a number of options. A first option allows the clearing authority to approve the clearance request. A second option allows the clearing authority to deny the clearance request. A third option allows the clearing authority to trigger a full review of the document, which causes the document to be reviewed by a member of the legal staff of the organization.

Note that the clearance request can be sent to the clearing authority within an email message, or alternatively through some other communication mechanism.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-controlled method for archiving and clearing a document for publication, comprising:
receiving the document to be archived at a computer system;
archiving the document, wherein archiving the document involves automatically recording a date upon which the document is archived;
receiving a request to clear the document for publication from a requesting party;
sending an approval request for the document to a first clearing authority;
upon receiving an approval from the first clearing authority, clearing the document for publication; and
upon receiving a denial from the first clearing authority, preventing the document from being cleared for publication.

2. The method of claim 1, further comprising providing the first clearing authority with a predetermined set of assumptions associated with approval of the document, so that the first clearing authority will understand the ramifications of approving the document.

3. The method of claim 1, further comprising:
upon receiving an approval from the first clearing authority, sending an approval request to a second clearing authority;
upon receiving an approval from the second clearing authority, clearing the document for publication; and
upon receiving a denial from the second clearing authority, preventing the document from being cleared for publication.

4. The method of claim 1, wherein sending the approval request to the first clearing authority involves sending an email message or other notification to the first clearing authority.

5. The method of claim 1, wherein sending the approval request to the first clearing authority involves presenting the first clearing authority with a number of options, including:
approving clearance of the document for publication;
denying clearance of the document for publication; and
triggering a full review of the document by legal staff to determine whether the document should be cleared for publication.

6. The method of claim 5, further comprising upon receiving a request for a full review of the document from the first clearing authority, triggering a full review of the document by legal staff.

7. The method of claim 1, wherein upon receiving a denial from the first clearing authority, the method additionally allows the first clearing authority to state reasons for the denial.

8. The method of claim 1, wherein upon receiving a request for additional information from the first clearing authority, the method further comprises:
forwarding the request for additional information to the requesting party; and
allowing the requesting party to provide the additional information to the first clearing authority.

9. The method of claim 1, further comprising allowing the first clearing authority to delegate approval authority.

10. A computer-readable storage medium storing instructions that when executed by a computer cause the computer to perform a method for archiving and clearing a document for publication, the method comprising:
receiving the document to be archived at a computer system;
archiving the document, wherein archiving the document involves automatically recording a date upon which the document is archived;
receiving a request to clear the document for publication from a requesting party;
sending an approval request for the document to a first clearing authority;
upon receiving an approval from the first clearing authority, clearing the document for publication; and
upon receiving a denial from the first clearing authority, preventing the document from being cleared for publication.

11. The computer-readable storage medium of claim 10, wherein the method further comprises providing the first clearing authority with a predetermined set of assumptions associated with approval of the document, so that the first clearing authority will understand the ramifications of approving the document.

12. The computer-readable storage medium of claim 10, wherein the method further comprises:
upon receiving an approval from the first clearing authority, sending an approval request to a second clearing authority;
upon receiving an approval from the second clearing authority, clearing the document for publication; and
upon receiving a denial from the second clearing authority, preventing the document from being cleared for publication.

13. The computer-readable storage medium of claim 10, wherein sending the approval request to the first clearing authority involves sending an email message or other notification to the first clearing authority.

14. The computer-readable storage medium of claim 10, wherein sending the approval request to the first clearing authority involves presenting the first clearing authority with a number of options, including:
approving clearance of the document for publication;
denying clearance of the document for publication; and
triggering a full review of the document by legal staff to determine whether the document should be cleared for publication.

15. The computer-readable storage medium of claim 14, wherein upon receiving a request for a full review of the document from the first clearing authority, the method further comprises triggering a full review of the document by legal staff.

16. The computer-readable storage medium of claim 10, wherein upon receiving a denial from the first clearing authority, the method additionally allows the first clearing authority to state reasons for the denial.

17. The computer-readable storage medium of claim 10, wherein upon receiving a request for additional information from the first clearing authority, the method further comprises:
forwarding the request for additional information to the requesting party; and
allowing the requesting party to provide the additional information to the first clearing authority.

18. The computer-readable storage medium of claim 10, wherein the method further comprises allowing the first clearing authority to delegate approval authority.

19. An apparatus that facilitates archiving and clearing a document for publication, comprising:
a receiving mechanism that is configured to receive the document to be archived at a computer system;
an archiving mechanism that is configured to archive the document, wherein archiving the document involves automatically recording a date upon which the document is archived;
wherein the receiving mechanism is configured to receive a request to clear the document for publication from a requesting party;
a clearing mechanism that is configured to send an approval request for the document to a first clearing authority;
wherein upon receiving an approval from the first clearing authority, the clearing mechanism is configured to clear the document for publication; and
wherein upon receiving a denial from the first clearing authority, the clearing mechanism is configured to prevent the document from being cleared for publication.

20. The apparatus of claim 19, wherein the clearing mechanism is configured to provide the first clearing authority with a predetermined set of assumptions associated with approval of the document, so that the first clearing authority will understand the ramifications of approving the document.

21. The apparatus of claim 19, wherein upon receiving an approval from the first clearing authority, the clearing mechanism is additionally configured to:
send an approval request to a second clearing authority;
clear the document for publication upon receiving an approval from the second clearing authority; and to
prevent the document from being cleared for publication upon receiving a denial from the second clearing authority.

22. The apparatus of claim 19, wherein the clearing mechanism is configured to send the approval through an email message or other notification to the first clearing authority.

23. The apparatus of claim 19, wherein the approval request presents the first clearing authority with a number of options, including:
approving clearance of the document for publication;
denying clearance of the document for publication; and
triggering a full review of the document by legal staff to determine whether the document should be cleared for publication.

24. The apparatus of claim 23, wherein upon receiving a request for a full review of the document from the first clearing authority, the clearing mechanism is configured to trigger a full review of the document by legal staff.

25. The apparatus of claim 19, wherein upon receiving a denial from the first clearing authority, the clearing mechanism is configured to allow the first clearing authority to state reasons for the denial.

26. The apparatus of claim 19, wherein upon receiving a request for additional information from the first clearing authority, the clearing mechanism is additionally configured to:
forward the request for additional information to the requesting party; and to
allow the requesting party to provide the additional information to the first clearing authority.

27. The apparatus of claim 19, wherein the clearing mechanism is configured to allow the first clearing authority to delegate approval authority.
